(19) United States
(12) Patent Application Publication
(10) Pub. No.: US 2008/0197125 A1
(43) Pub. Date: Aug. 21, 2008

(54) SUBSTRATE HEATING METHOD AND APPARATUS

(75) Inventors: ANQING CUI, Sunnyvale, CA (US); Sean M. Seutter, San Jose, CA (US); Jacob W. Grayson, Santa Clara, CA (US); R. Suryanarayanan Iyer, St. Paul, MN (US)

Correspondence Address: MOSER IP LAW GROUP / APPLIED MATERIALS, INC., 1030 BROAD STREET, 2ND FLOOR, SHREWSBURY, NJ, 07702, US

(73) Assignee: Applied Materials, Inc., Santa Clara, CA (US)

(21) Appl. No.: 11/675,856

(22) Filed: Feb. 16, 2007

(51) Int. Cl. H05B 3/10; G06F 19/00

(52) U.S. Cl. 219/548; 702/99

(57) ABSTRACT

Embodiments of substrate heating methods and apparatus are provided herein. In one embodiment, a substrate heater is provided including a heater plate having a top surface and an opposing bottom surface, a recess formed in the top surface, the recess having a feature having an upper surface for supporting a substrate, wherein the depth from a bottom surface of the recess to the upper surface of the feature is at least 5 mils. One or more pads may be disposed in the recess for supporting a substrate. The heater plate may have a thickness of about 19 mm. One or more indentations may be formed in the bottom surface of the recess for altering the rate of heat transfer to a portion of a substrate disposed above the indentation during processing. The heater plate may be utilized in a process chamber for performing heat-assisted processes.

### BACKGROUND OF THE INVENTION

1. Field of the Invention

Embodiments of the present invention generally relate to semiconductor fabrication. More specifically, the present invention relates to a method and apparatus for heating a substrate during semiconductor fabrication.

2. Description of the Related Art

In semiconductor fabrication processes, the temperature of the substrate is often a critical process parameter. Changes in, and gradients across the substrate surface during processing may undesirably affect the process, such as by causing non-uniform material deposition and/or removal, or the like, thereby leading to lesser quality and lower yields.

A number of methods exist to control substrate temperature during processing. One method feeds a chilled fluid through a substrate support pedestal during substrate processing. The fluid removes heat from the substrate support pedestal thus cooling the substrate. However, the response time required to bring a substrate to a desired temperature is relatively long. As such, rapid, dynamic control of the fluid temperature to compensate for rapid substrate temperature fluctuations is not feasible. Consequently, it is difficult to maintain the substrate at a desired temperature during processing.

Another method of controlling substrate temperature that provides more rapid dynamic control of the pedestal temperature uses thermoelectric devices (such as resistive heating elements) embedded in the pedestal surface that supports the substrate. These devices are disposed in an array below the support surface of the pedestal. However, temperature gradients form between the individual devices within the array, i.e., each device transfers heat at its location while a lesser amount of heat is transferred at the locations between the devices. Such gradients between a these devices may cause substantial temperature variation across the substrate, thereby leading to undesired process variations across the substrate.

Thus, there is a need for improved substrate heating methods and apparatus.

### SUMMARY OF THE INVENTION

Embodiments of substrate heating methods and apparatus are provided herein. In one embodiment, a substrate heater is provided including a heater plate having a top surface and an opposing bottom surface, a recess formed in the top surface, the recess having a feature having an upper surface for supporting a substrate, wherein the depth from a bottom surface of the recess to the upper surface of the feature is at least 5 mils. One or more pads may be disposed in the recess for supporting a substrate. The heater plate may have a thickness of about 19 mm. One or more indentations may be formed in the bottom surface of the recess for altering the rate of heat transfer to a portion of a substrate disposed above the indentation during processing. The heater plate may be utilized in a process chamber for performing heat-assisted processes.

In another aspect of the present invention, a method of calibrating a substrate heater is provided. In some embodiments, the method includes heating a substrate with the substrate heater; determining an initial thermal profile of the substrate; and modifying at least one local rate of thermal transfer of the substrate heater in response to the initial thermal profile.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts a cross-sectional view of a substrate heating apparatus in accordance with an embodiment of the present invention;

FIG. 2 depicts a top view of a substrate heating apparatus in accordance with an embodiment of the present invention;

FIG. 3 depicts a schematic diagram of a reactor for use with a substrate heater in accordance with one embodiment of the present invention; and

FIG. 4 depicts a flow diagram of a substrate heating method in accordance with one embodiment of the present invention.

To facilitate understanding, identical reference numerals have been used, where possible, to designate identical elements that are common to the figures. In addition, the figures may be simplified for ease of understanding and are not necessarily drawn to scale.

### DETAILED DESCRIPTION

The present invention provides methods and apparatus for heating a substrate during semiconductor processing. The inventive apparatus facilitates more uniform heating of substrates as compared to conventional devices.

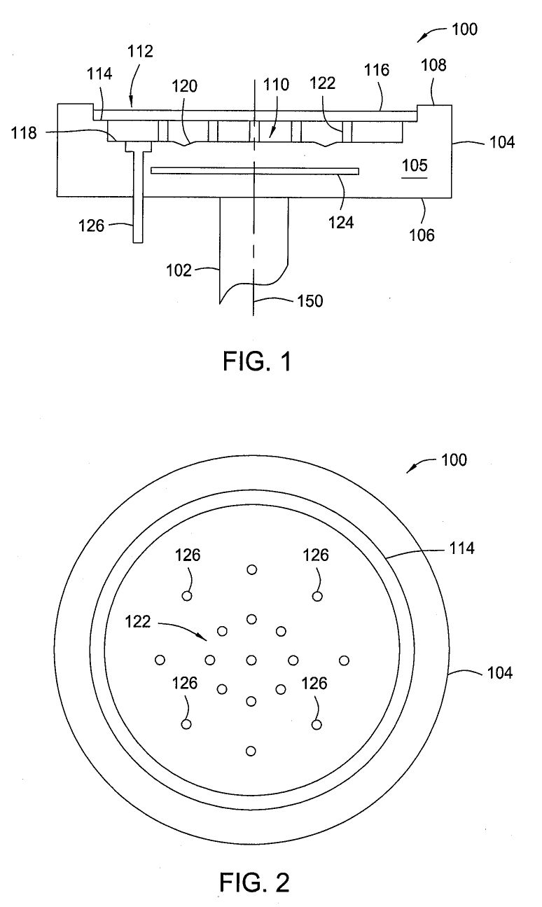

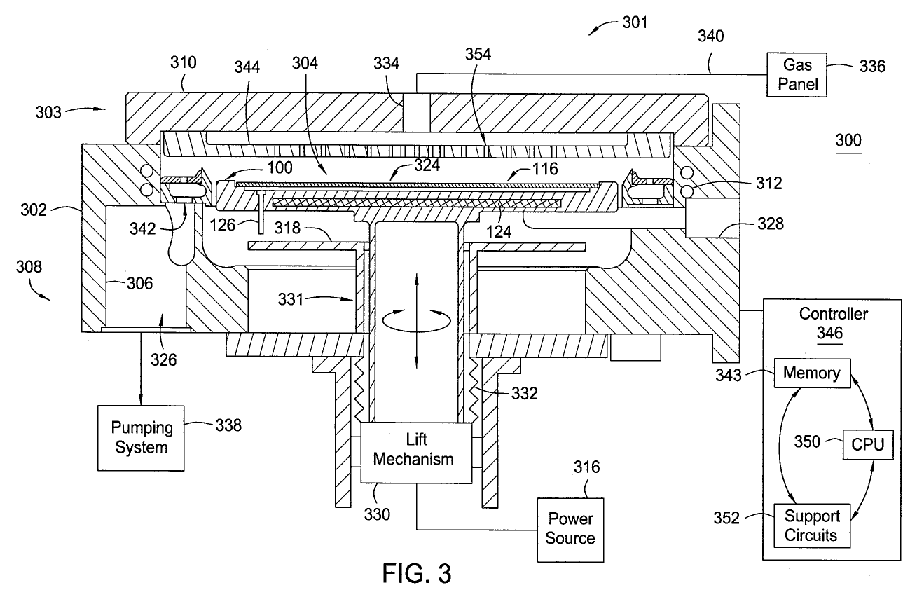

FIG. 1 depicts a cross-sectional view of a substrate heating apparatus (“substrate heater”) 100 in accordance with some embodiments of the present invention. The substrate heater 100 generally comprises a heater plate 104 that may be coupled to a stem 102. The stem 102 may be used, for example, to secure the heater plate 104 to a base of a process chamber, as discussed below with respect to FIG. 3. The stem 102 may be affixed to a center of a bottom surface 106 of the heater plate 104 and may be aligned with respect to a central axis 150 of the heater plate 104. Alternatively, the stem 102 may be slightly off-center with respect to the central axis 150 to compensate for known temperature non-uniformities that may be due to variations in components of the substrate heater 100 or in a process chamber in which the substrate heater 100 is installed. Alternatively, the heater plate 104 may be secured without the stem 102 to other components of a process chamber in which the substrate heater 100 is to be used, such as to an upper surface of a substrate support pedestal. The stem 102 may be hollow to provide facilities access for the heater plate 104 (e.g., to allow electrical and/or fluid connections or the like to be made with the heater plate 104 from outside a process chamber).

The heater plate 104 may be made out of any materials suitable to withstand processing conditions, such as ceramic, stainless steel, aluminum, or pyrolitic boron nitride and generally includes a body 105 having a top surface 108 configured to support a substrate 116, such as a 200 or 300 mm semiconductor wafer or the like. At least one heating element 124 may be disposed within the body 105 for supplying heat to the substrate 116 during processing. The heating element 124 may comprise one or more resistive elements that may be coupled to a power source to supply a desired quantity of heat to the substrate 116 during processing. The heating element 124 may be one or more coils constructed of suitable materials, such as in a non-limiting example of a nichrome wire surrounded with an MgO insulation within a metal sheath. Typically, the metal sheath may be made of Incoloy®, Inconel®, stainless steel, or other metal capable of withstanding the high temperatures reached during casting/welding. Alternatively, or in combination, a multi-loop heating element (not shown) may be embedded in the body 105 of the heater plate 104. Although a single heating element 124 is shown in FIG. 1, it is contemplated that multiple heating elements may be provided and configured in planar arrays, non-planar arrays, or any desired geometry to heat a substrate as desired (for example, uniformly) during processing.

In some embodiments, the body 105 may be about 17 mm thick. Alternatively, the body may have a thickness in a range of about 18 mm to 22 mm (about 708.7 mils to about 866.1 mils), or in one embodiment, about 19 mm (about 748.0 mils). The increased thickness of the body 105 of the substrate heater 104 advantageously facilitates distributing heat more evenly to improve the temperature uniformity of the substrate heater 104 as compared to conventional heaters.

A pocket 112 may be formed in a top surface 108 of the heater plate 104 to locate and support the substrate 116. The substrate 116 may rest on a bottom surface 118 of the pocket 112, or alternatively and as shown in FIG. 1, the substrate 116 may be supported above the bottom surface 118 by a ledge 114 or other feature disposed about the periphery of the pocket 112, thereby forming a recess 110 disposed between the substrate 116 and the bottom surface 118. In some embodiments, the heating element 124 may be disposed at least 5 mm below the bottom surface 118 of the pocket 112, thereby facilitating more even heat distribution, as discussed above.

In some embodiments, the depth of the recess 110 may be at least about 0.03 mm (about 1.2 mils). Alternatively, the depth of the recess 110 may be at least about 0.12 mm (about 5 mils), or in one embodiment, at least about 0.18 mm (about 7 mils). The increased distance between the substrate 116 and the bottom surface 118 advantageously facilitates even distribution of heat from the heating element 124, thereby improving temperature uniformity of the substrate 116. In addition, during a heating process, the substrate 116 may tend to deflect or sag into the recess 110. During conventional processing, the deflection may cause the substrate 116 to contact the heating surface 118, potentially damaging the substrate 116 or causing temperature non-uniformities. The increased depth of the recess 110 of at least about 7 mils minimizes the likelihood of the substrate 116 coming into contact with the bottom surface 118 during processing.

Optionally, one or more pads 122 may be provided in the recess 110 to support the substrate 116 when disposed in the pocket 112 and resting on the ledge 114. The pads 122 may be at least as tall as the depth of the recess 110. The pads 122 are generally configured to provide support for the substrate 116 while not interfering with the temperature distribution thereof. The pads 122 may be in any shape, and in one embodiment are cylindrical having a diameter in the range of between about 2 and 3 mm, and in one embodiment, about 2.5 mm.

The pads 122 may be arranged in any number and geometry, or pattern. For example, FIG. 2 depicts a top view of the substrate heater 100 in accordance with some embodiments of the present invention. As depicted in FIG. 2, the optional pads 122 may be arranged in a radial array to support to the substrate 116 without causing significant interference in the heating of the substrate 116 during processing. It is contemplated that greater or fewer pads 122 may be utilized and may be arranged in any geometry (such as rectangular, circular, spiral, wavy, polygonal, random, or the like). When used, there may be at least one pad 122. In some embodiments, up to about 50 pads 122 are utilized, or in some embodiments about 33 pads 122 are utilized.

Optionally, the bottom surface 118 of the recess 110 may have a at least one indentation 120 (two indentations 120 depicted in FIG. 1). The indentations 120 increase the depth of the recess 110 at the location of the indentation 120, thereby decreasing the rate of heat transfer from the bottom surface 118 to the substrate 116 during processing at the location of the indentation 120. The indentations 120 may be formed after running an exemplary heat process (such as heating a blanket wafer) on a substrate and determining the temperature profile of an upper surface of the substrate. Indentations 120 may then be formed at locations corresponding to hotter regions of the substrate. Thus, the rate of heat transfer may be locally modified to obtain more uniform heating of a substrate during processing.

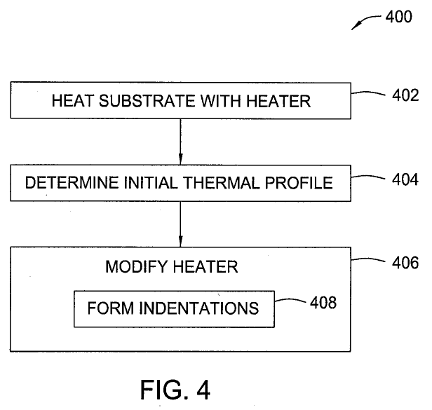

FIG. 4 depicts a flow diagram of a method 400 for calibrating a substrate heater in accordance with some embodiments of the present invention. The method 400 is discussed with reference to FIGS. 1-2. The method 400 begins at step 402, where a substrate 116 is heated with the substrate heater 100. The substrate 116 may be heated to a predetermined temperature (such as corresponding to a typical processing temperature, a maximum processing temperature, or the like).

Next, at step 404, an initial thermal profile of a substrate 116 is determined. The initial thermal profile typically corresponds to a thermal profile of the substrate 116 immediately or shortly after being heated as discussed above with respect to step 402. The thermal profile may be determined by directly or indirectly measuring the temperature at a plurality of locations on the substrate 116. The temperature profile may correspond to the entire surface of the substrate 116 or to selected regions thereof.

Next, at step 406, the substrate heater 100 may be modified in response to the determined initial thermal profile of the substrate 116. The modification of the substrate heater 100 may include forming one or more indentations in the bottom surface 118 corresponding to regions of the substrate 116 having a higher than desired temperature, as discussed above and shown here as sub-step 408. Although the above methods are discussed with respect to providing a uniform thermal profile of a substrate, it is contemplated that the above methods may be utilized to obtain other desired thermal profiles that may be non-uniform.

The method 400 may be repeated to confirm results or to make further modifications to the substrate heater 100. After completion of the desired modifications, the method ends and further substrate processing may be performed using the modified substrate heater 100 to heat the substrate 116 as desired.

Returning to FIG. 1, optionally, a mechanism may be provided to assist in the placement and/or removal of the substrate 116 on the substrate heater 100. For example, in the embodiment depicted in FIG. 1, a plurality of lift pins (one lift pin 126 illustratively shown in FIG. 1) may be provided to interface with a lift plate disposed in a process chamber to selectively raise or lower the substrate 116 from or to the substrate heater 100, as discussed in more detail with respect to FIG. 3, below. It is contemplated that other mechanisms besides lift pins and lift plates may be utilized to selectively position the substrate 116 on the substrate heater 100.

The substrate heater 100 may be utilized in various process chambers suitable for substrate processing, including but not limited to semiconductor substrate processes such as rapid thermal processing (RTP), annealing, chemical or physical vapor deposition (CVD or PVD), or the like. Process chambers suitable for use with the substrate heater described herein include, for example, SiNgen® and POLYGEN™ chambers commercially available from Applied Materials, Inc., of Santa Clara, Calif. Other examples of suitable processing chambers are described in U.S. patent application Ser. No. 10/911,208, filed Aug. 4, 2004 by lyer, et al., and U.S. patent application Ser. No. 11/147,938, filed Jun. 8, 2005 by Smith, et al., which are hereby incorporated by reference in their entirety. In addition, examples of suitable heaters that may be modified in accordance with the teachings disclosed above include U.S. Pat. No. 6,423,949, issued Jul. 23, 2002, to Chen, et al., and entitled “Multi-Zone Resistive Heater,” and U.S. Pat. No. 6,617,553, issued Sep. 9, 2003, to Ho, et al., and entitled “Multi-Zone Resistive Heater.” Each of the aforementioned patents are herein incorporated by reference.

FIG. 3 depicts a schematic diagram of an illustrative reactor suitable for use with a substrate heater as described above in accordance with some embodiments of the present invention. In the embodiment depicted in FIG. 3, the reactor 300 comprises a processing chamber 301, a pumping system 338, a gas panel 336, a power source 316, and a controller 346. The processing chamber 301 generally includes an upper assembly 303, a bottom assembly 308, and a pedestal lift assembly 331. The upper assembly 303 generally comprises a lid 310 having an inlet port 334 and a showerhead 344. The bottom assembly 308 houses a substrate support assembly 324 (comprising the substrate heater 100) and comprises a chamber body 302 having a wall 306. A substrate access port 328 is formed in the chamber body 302 to facilitate entry and egress of a substrate 116 into and out of the processing chamber 301. The pedestal lift assembly 331 is coupled to the substrate support assembly 324 and comprises a lift mechanism 330 and a lift plate 318 configured to interface with lift pins 126. Although four lift pins 126 are illustratively shown in FIG. 4, it is contemplated that greater or fewer lift pins 126 may be utilized.

The substrate support assembly 324 and substrate heater 100 are disposed in an internal volume 304 of the processing chamber 301. The electrode 124 of the substrate heater 100 is coupled to the power source 316 and is configured to provide sufficient heat to maintain the substrate 116 at a desired temperature. In one exemplary, non-limiting embodiment, the substrate heater 100 may be configured to heat the substrate 116 up to about 800 degrees Celsius. It is contemplated that the substrate heater 100 may be capable of providing greater or lesser heat to the substrate 116.

The showerhead 344 provides, through a plurality of openings 354, distribution of gases or vapors delivered from the gas panel 336. Size, geometry, number, and location of the openings 354 are selectively chosen to facilitate a predefined pattern of gas/vapor flow to the substrate 116.

The gas panel 336 provides process chemicals, in liquid and/or gaseous form, to the processing chamber 301. The gas panel 336 may be coupled to the lid 310 using a plurality of gas lines 340. Each gas line 340 may be selectively adapted for transferring specific chemical(s) from the gas panel 336 to the inlet port 334, as well as be temperature controlled.

In operation, the pedestal lift assembly 330 controls the elevation of the substrate heater 100 between a processing position (as shown in FIG. 3) and a lowered position from which the substrate 116 may transported, through the substrate access port 128, into and out of the processing chamber 301. The assembly 301 is sealingly coupled to the chamber body 302 using a flexible bellows 332 and, optionally, is configured to rotate the substrate heater 100.

The wall 306 may be thermally regulated. In one embodiment, a plurality of conduits 312 may be disposed in the wall 306 and configured to circulate a heat transfer fluid regulating the temperature of the wall.

The pumping system 338 is coupled to a pumping port 326 formed in the wall 306. The pumping system 338 generally includes a throttle valve and one or more pumps arranged to control the pressure in the internal volume 304. Gases flowing out of the processing chamber 301 are routed through a pumping ring 342 to enhance gas flow uniformity across the surface of the substrate 116. One such pumping ring is described in U.S. patent Ser. No. 10/911,208, filed Oct. 4, 2004, by lyer, et al., and entitled “Thermal Chemical Vapor Deposition of Silicon Nitride Using BTBAS Bis(Tertiary-Butylamino Silane) in a Single Wafer Chamber,” which is herein incorporated by reference.

In alternate embodiments (not shown), the reactor 300 may comprise a photoexcitation system to deliver radiant energy to the substrate 116 through windows in the lid 310, as well as a remote plasma source coupled to the inlet port 334.

The system controller 346 generally comprises a central processing unit (CPU) 350, a memory 343, and support circuits 352 and is coupled to and controls modules and apparatuses of the reactor 300. In operation, the controller 346 directly controls modules and apparatus of the system 300 or, alternatively, administers computers (and/or controllers) associated with these modules and apparatuses.

Thus, a substrate heater suitable for providing more controlled heat to a substrate has been provided. The substrate heater may further be modified to provide even greater control over the desired substrate thermal profile as compared to conventional substrate heaters.

While the foregoing is directed to embodiments of the present invention, other and further embodiments of the invention may be devised without departing from the basic scope thereof, and the scope thereof is determined by the claims that follow.

1. A substrate heater comprising:
a heater plate having a top surface and an opposing bottom surface, a recess formed in the top surface, the recess having a feature having an upper surface for supporting a substrate, wherein the depth from a bottom surface of the recess to the upper surface of the feature is at least 5 mils.

2. The substrate heater of claim 1, further comprising at least one pad disposed in the recess for supporting a substrate.

3. The substrate heater of claim 2, comprising about 33 pads.

4. The substrate heater of claim 1, further comprising:
a heating element disposed within the heater plate beneath the recess.

5. The substrate heater of claim 4, wherein the heating element is disposed at least about 5 mm below the bottom surface of the recess.

6. The substrate heater of claim 1, further comprising:
a stem aligned along a central axis of the heater plate.

7. The substrate heater of claim 1, wherein the heater plate has a thickness in a range of about 18 mm to 22 mm.

8. The substrate heater of claim 1, wherein the heater plate has a thickness of about 19 mm.

9. The substrate heater of claim 1, wherein the feature comprises a ledge extending about a periphery of the recess.

10. The substrate heater of claim 1, further comprising:
one or more indentations formed in the bottom surface of the recess for altering the rate of heat transfer to a portion of a substrate disposed above the indentation during processing.

11. A substrate processing system comprising:
an process chamber; and
a substrate heater disposed within the process chamber, the substrate heater comprising:
a heater plate having a top surface and an opposing bottom surface, a recess formed in the top surface, the recess having a feature including an upper surface for supporting a substrate, wherein the depth from a bottom surface of the recess to the upper surface of the feature is at least 5 mils; and
a heating element disposed within the heater plate beneath the recess.

12. The substrate processing system of claim 11, further comprising at least one pad disposed in the recess for supporting a substrate.

13. The substrate processing system of claim 11, wherein the heater plate has a thickness in a range of about 18 mm to 22 mm.

14. The substrate processing system of claim 11, wherein the heater plate has a thickness of about 19 mm.

15. The substrate processing system of claim 11, further comprising:
one or more indentations formed in the bottom surface of the recess for altering the rate of heat transfer to a portion of a substrate disposed above the indentation during processing.

16. The substrate processing system of claim 11, wherein the heating element is disposed at least about 5 mm below the bottom surface of the recess.

17. A method for calibrating a substrate heater, comprising:
heating a substrate with the substrate heater;
determining an initial thermal profile of the substrate; and
modifying at least one local rate of thermal transfer of the substrate heater in response to the initial thermal profile.

18. The method of claim 17, wherein the modifying step further comprises:
forming one or more indentations in a bottom surface of a recess formed in the substrate heater and disposed beneath the substrate corresponding to regions of the substrate having a higher than desired temperature.
